(19) United States
(12) Patent Application Publication
(10) Pub. No.: US 2004/0171721 A1
(43) Pub. Date: Sep. 2, 2004

(54) Stabilizing polyalkylene carbonate resins

(76) Inventor: Pascal E. Esemplare, Mountainside, NJ (US)

Correspondence Address: Pascal E. Esemplare, 583 Woodland Avenue, Mountainside, NJ, 07092, US

(21) Appl. No.: 10/736,032

(22) Filed: Dec. 13, 2003

Related U.S. Application Data
(60) Provisional application No. 60/433,822, filed on Dec. 16, 2002.

(51) Int. Cl. C08K 5/34

(52) U.S. Cl. 524/100

(57) ABSTRACT

Polyalkylene carbonate resins are stabilized against thermal and hydrolytic decomposition by the addition of a cyclic amine eliminating the need for complex chemical or other purifying techniques. Cyclic amines such as imidazole and substituted imidazoles (specifically 2-ethyl 4-methyl imidazole) were found to be effective at 5-30%, preferably 10-30%. Processes for producing stable flux containing coatings for the aluminum brazing industry are detailed. The modified polyalkylene carbonate resins have better adhesive properties than the unmodified resins while maintaining their low ash, clean burning characteristics.

### BACKGROUND

Poly(alkylene carbonates) are copolymers of carbon dioxide and 1,2-epoxides. They are easily prepared by reacting an aliphatic or cycloaliphatic epoxide, e.g. ethylene oxide, propylene oxide, isobutylene oxide in a solvent under a pressure of 100 to 700 psig of carbon dioxide using an organometallic catalyst, typically zinc carboxylate for up to 40 hours at 25° C. to 110° C.

These polymers can also be prepared by reacting a diol having at least 4 carbons separating the hydroxyl groups with a diester of carbonic acid in the presence of a catalyst selected from tertiary amines, alkylammonium salts, pyridinium salts, and basic ion-exchange resins that contain active alkylammonium or tertiary amino groups. The end groups are either hydroxyls or carbonate esters.

According to Stevens (in U.S. Pat. Nos. 3,248,414; 3,248,415 and 3,248,416, poly(alkylene carbonate) polyols are prepared by reacting (a) carbon dioxide and 1,2-epoxides; (b) cyclic carbonates such as ethylene carbonate; or (c) cyclic carbonates and a 1,2-epoxide. A minor amount of a polyol is used as an initiator.

U.S. Pat. No. 3,248,415 to Stevens discloses that certain polyamines can be used as initiators in reactions with alkylene carbonates or alkylene oxides and carbon dioxide. These polyamines include: other organic compounds having at least 2 active hydrogens usually from 2-4 active hydrogens are used. By active hydrogen is meant a hydrogen linked directly to a nitrogen, sulfur or oxygen atom such as is found in hydroxyl, non-tertiary amino, mercapto, carbamate and carboxyl groups. Each active hydrogen is linked to a different nitrogen, sulfur or oxygen atom in the compound.

Polyamines, especially diamines in which the amino groups are primary or secondary are suitable organics containing 2 active hydrogens. Piperazine and like polyamines wherein each of the nitrogens has one hydrogen linked thereto (secondary amino nitrogens) are preferred, according to Stevens.

Residual catalyst fragments in poly(alkylene carbonates) have a detrimental effect on the stability of these polymers by catalyzing depolymerization reactions (“unzipping”). The higher the temperature, the higher the rate of depolymerization. Even the terminal hydroxyl groups adversely affect the stability of these copolymers and stability is improved by reacting the free hydroxyl groups with a hydroxyl reactive phosphorus compound as disclosed by Dixon et al, in U.S. Pat. No. 4,145,525.

Prior in U.S. Pat. No. 4,528,364, states that the presence of alkaline catalysts remaining in polyalkylene carbonate polyols adversely affect the performance and that these fragments must be removed. In addition, water (moisture) has a detrimental effect, hydrolyzing the polyalkylene carbonate.

Poly(propylene carbonate), for example, decomposes to propylene carbonate by an unzipping mechanism and scission of the carbonate linkage via hydrolysis. Unzipping starts at the end of the chain and continues to proceed by producing more cyclic monomer (propylene carbonate) as the length of the chain decreases. This is an equilibrium reaction where depolymerization and subsequent polymerization occur.

The propylene carbonate produced acts as a placticizer for the polymer and thus the product as received by the customer becomes clumped together. Pellets of QPac polyalkylene carbonate (Trademark, Empower Materials, Inc., Newark, Del.) become stuck together and very difficult to separate; similarly, powdered product becomes one solid mass. This is why the additional processing described above (removal of cayalyst residues and reacting the terminal hydroxyl groups) is required.

### SUMMARY OF INVENTION

Prior art states that polyalkylene carbonates must be purified to be viable in commercial applications. Referenced patents describe purification techniques employed. I have developed a simple chemical system that achieves stability through a cross-linking mechanism eliminating the need for any of the above mentioned purification techniques which makes polyalkylene carbonates both hydrolytically and thermally stable. In addition the adhesion of polyalkylene carbonates to various substrates is improved and the toughness of the film is increased. Of critical importance is the fact that this addition does not impair the clean burning characteristics of the polyalkylene carbonates.

### DETAILED DESCRIPTION OF INVENTION

The chemical that I add is imidazole or 2-ethyl 4-methylimidazole. These are cyclic amines. Their addition to polyalkylene carbonates results in cross-linking of these thermoplastic materials and this cross-linking improves their stability and physical properties. This addition inhibits the depolymerization reaction described above. It produces a stable product without the need to remove catalyst fragments or react terminal hydroxy group with phosphorus compounds. Further, moisture no longer is a problem. Purification of the polyalkylene carbonates is no longer required.

Although it is not necessary to use purified poly(alkylene carbonates) in this invention, it is important to understand the depolymerization reactions because they contribute to the cross-linking or formation of a three-dimensional network, which is an essential aspect of the invention.

In other words, I take an inherent defect in the polymer as produced and use it as part of our cross-linking mechanism yielding a stable polymer and therefore a viable product in the coatings industry as compared to an unstable coating which inherently decomposes and this decomposition is accelerated by heat and moisture rendering the coating a sticky mass.

The polyalkylene carbonate resin and the imidazole are dissolved in a suitable solvent at ambient temperature with stirring to obtain a homogeneous mix. Solvation can be accelerated with heat. In my experiments I used methyl ethyl ketone (MEK) and propylene glycol mono methyl ether acetate (PMA) but there are many suitable solvents.

This invention produces a stable, flexible tough film after the solvent is removed. Solvent removal can be accelerated with heat with no detrimental effects. Cross linking can be accomplished with a minimum of twelve hours at ambient temperature after the solvent has been evaporated. Temperatures ranging from 2 minutes @70° C. to 15 minutes @150° C. have successfully been used cross linking at elevated temperatures. Stable non-tacky coatings are produced even using polyalkylene carbonate emulsions.

The active hydrogen on the cyclic amines (imidazole) is directly responsible for the cross-linking of these materials. It is known that polyalkylene carbonate polyols are produced by reacting an alkylene carbonate, or alkylene oxide and carbon dioxide with an organic compound having at least one active hydrogen atom in the presence of an alkaline catalyst. Examples of these polyalkylene carbonate polyols and methods for their preparation are contained in Maximovich, U.S. Pat. No. 3,896,090; Maximovitch, U.S. Pat. No. 3,689,462; Springman, U.S. Pat, No. 3,313,782; and in Stevens in the patents cited above.

A functional group containing a reactive hydrogen means any moiety which contains a hydrogen atom which will readily liberate the hydrogen atom and react with monomeric or polymeric alkylene carbonates. More specifically, reactive hydrogen means herein a hydrogen linked directly to nitrogen, oxygen or sulfur atom, such as is found in a non-tertiary amine, amide, hydroxy, mercapto or carboxyl group.

The organic compounds containing active hydrogen atoms of this invention contain one or more of the following functional groups: hydroxyls, amines, mercaptans, carboxyls, sulfones, amides, imides, or carbonates.

Among desirable active hydrogen-containing organic compounds are polyamines; polyols—aliphatic polyols, cycloaliphatic polyols, and polyols which contain oxy or ether groups; polymercaptans; polyamides; polycarboxylic acids; alkylolamines and organic compounds which contain three or more of the above described functional groups containing reactive hydrogens.

The preferred classes are cyclic amines.

Examples of cyclic amines are imidazoles, hydantoins, triazines, pyrimidines, imidazolines and their derivatives which still possess at least one amino hydrogen. These include; imidazolidin-4-one and its derivatives; triazine-2,4-dione and its derivatives; cyanuric acid; and 5,5-dimethyl hydantoin.

Cross-linking Mechanism: The first step is the attack on the linear chain by the secondary amine, R₂NH to produce a tertiary amine in the cleavage reaction. The second step in the process is the reaction of the tertiary amine with the carbonate to form a quaternary ammonium salt, which combines with anionic groups on adjacent chains in the system, as shown schematically:

First Step:

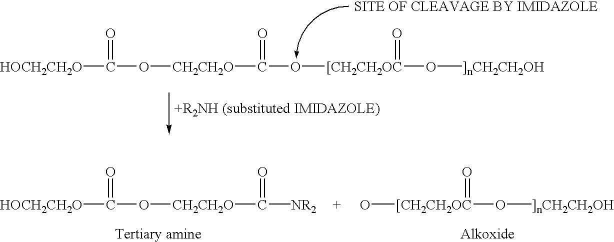

Second step: Reaction of tertiary amine with carbonate on polymer chain to form a quaternary ammonium salt

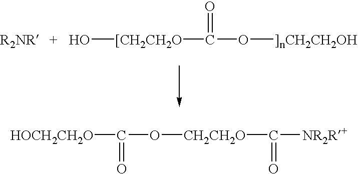

This combines with anionic groups on adjacent chains in the system:

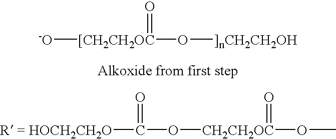

The alkoxide cleaves the O—CH₂ bond in the cyclic carbonate (propylene carbonate) to generate carbonate anions:

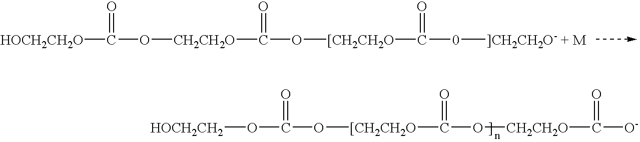

The carbonate anions are capable of initiating polymerization of the cyclic carbonate and can combine with the quaternary ammonium groups on a neighboring chain in an exchange reaction.

M=propylene carbonate monomer

In the depolymerization or unzipping reaction, as the cyclic monomer is formed, it leaves a chain with hydroxyl end groups. These free hydroxyls also initiate polymerization of the cyclic carbonate via an anionic mechanism and this polymerization is subsequently terminated with quaternary ammonium ions of a branched chain. Moreover, this polymerization is catalyzed by tertiary and quaternary amine groups. This results in the formation of the three-dimensional network. In essence, the carbonate and alkoxide ions combine with the quaternary ammonium nitrogens to produce the cross linked gel.

Known in the industry as CO₂ polymers, poly(alkylene carbonates) are thermoplastic materials and their first commercial application was the deployment of poly(propylene carbonate) as a binder in metals/ceramics formulations for the electronics industry. The relevant properties are low decomposition temperatures, very low ash residues and clean products of combustion. One of the important aspects of this invention is that the cross linked polyalkylene carbonates still depolymerize at low temperatures and burn clean with very low ash residues comparable to the thermoplastic base polyalkylene carbonate.

### SPECIFIC EMBODIMENTS

The following examples are included for illustrative purposes only, and do not limit the scope of the invention or the claims. Unless otherwise stated, all parts and percentages are by weight.

### EXAMPLE I

A sprayable formulation for aluminum sheet for the aluminum brazing industry based on this technology is as follows:

| Ingredient | % |
|---|---|
| Polypropylene carbonate | 5.72 |
| Propylene glycol methyl ether acetate | 34.59 |
| Methyl Ethyl Ketone | 49.00 |
| 2-ethyl 4-methylimidazole* | 0.69 |
| KAl F₄ | 10.00 |

*This is one of a series of substituted imidazoles commercially available from Air Products, Allentown, PA. under the “Curezol” and “Incure” Tradenames.

The first four ingredients are stirred at ambient temperature until totally dissolved and then the flux (KalF₄) is dispersed in this mixture. The mixture is sprayed onto an aluminum substrate and the solvents removed by air drying and/or heating. The coating then is quick cured e.g. 2′@70° C. The coating is now tough and stable with good adhesion to the base metal. It can now be stacked, formed into a coil or otherwise packaged and transported without any possibility of flaking or dusting. It delivers the proper amount of flux for brazing, eliminating waste and health hazards. The coated sheets were cut and shaped into different forms and heated by torch to produce brazed joints that were very clean with minimal residue.

### EXAMPLE II

A dipping formulation for aluminum rings using cesium aluminum fluoride as the flux and imidazole as the cross linking agent is as follows:

| Ingredient | % |
|---|---|
| Polypropylene Carbonate | 15.0 |
| Imidazole | 2.5 |
| Propylene glycol methyl ether acetate | 20.0 |
| Methyl Ethyl Ketone | 30.0 |
| Cesium Aluminum Fluoride | 32.5 |
| | 100.0 |

The first four ingredients are stirred at ambient temperature until totally dissolved and then the powered flux (cesium aluminum fluoride) is dispersed in the mixture. The rings are dipped into the mix, air dried and then cured 2′@70° C. The rings now have a tough flux coating that can take rough handling.

### EXAMPLE III

Coating Alcoa 718 Aluminum Silica rods by a dipping technique. The flux used was KalF₄/CsAlF₄ (95/5).

Formulation:

| Ingredient | % |
|---|---|
| Polypropylene Carbonate | 9.78 |
| 2-ethyl 4-methylimidazole | 1.20 |
| Propylene glycol methyl ether acetate | 22.82 |
| Methyl Ethyl Ketone | 36.26 |
| KAlF₄/CsAlF₄ | 29.94 |
| | 100.00 |

Again the first four ingredients are stirred at ambient temperature until totally dissolved and the flux is dispersed in the mixture. The rods were dipped into the above mix and cured 5′@55° C. A tough flux coating with good adhesion resulted. Retains of these rods are exactly as made after 4 years storage at ambient temperature. There is no sign of depolymerization and they are non tacky.

### EXAMPLE IV

Examples demonstrating improved adhesion and toughness. In all these formulations the polypropylene carbonate and the 2-ethyl 4-methylimidazole were dissolved in Methyl Ethyl Ketone and then the flux was dispersed in the solution. Samples one through five were sprayed onto steel Q panels, air dried for solvent removal and cured fifteen minutes at 150° C. in a laboratory oven.

| | % Polypropylene | | % 2-ethyl 4-methyl | 2-ethyl4-methyl |
|---|---|---|---|---|
| Sample | Carbonate | % KAlF₄ flux | imidazole | imidazole phr |
| #1 Control | 36.39 | 63.61 | — | — |
| #2 | 34.86 | 60.94 | 4.20 | 12.05 |
| #3 | 33.92 | 59.28 | 6.80 | 20.05 |
| #4 | 32.83 | 57.40 | 9.77 | 29.76 |
| #5 | 22.56 | 67.67 | 9.77 | 43.30 |

Note:
The percentages listed are weight percent in the solid coating after solvent evaporation. The last column is parts of the imidazole per hundred of the polycarbonate resin.

In sample #5 the flux content was increased to see if the binder system could handle higher loadings. As we go from sample 1 through 5 the end product is progressively tougher and shows improved adhesion. Sample #1 on a Q panel and bent over a ⅛ inch mandrel flakes off. Sample #2 can be pried off, Sample #3 could not be removed, and samples #4 and #5 can be twisted, bent and hammered and the coating does not come off.

I believe the adhesion is also helped by the fact that the imidazole lowers the contact angle and improves the flow properties of the polypropylene carbonate enabling it to wet the substrate better.

### EXAMPLE V

This invention can be modified so as to function in an ultrasonic spray system. This is a low-pressure system which delivers precise spraying and essentially eliminates over spray. We worked with the Sono-Tek Corporation of Melton, N.Y. The formulation was adjusted as follows to accommodate the Sono-Tek equipment.

| Ingredient | % |
|---|---|
| Polypropylene Carbonate | 2.6 |
| Propylene glycol methyl ether acetate | 41.18 |
| Methyl Ethyl Ketone | 50.00 |
| 2-ethyl 4-methylimidazole | 0.34 |
| KAl F₄ | 5.88 |
| | 100.00 |

The first four ingredients are stirred at ambient temperature until totally dissolved and then the flux (potassium aluminum fluoride) was added with stirring. Aluminum strips approximately ¾ inch wide were coated and air dried for several minutes then dried and cured in an over at 70° C. for 3-4 minutes. The coatings produced were tough exhibiting good adhesion.

### EXAMPLE VI

Using Polypropylene Carbonate emulsion for a water based system.

| Ingredient | % |
|---|---|
| Polypropylene Carbonate Emulsion (24.5% solids) | 23.20 |
| Water | 66.13 |
| 2-ethyl 4-methylimidazole | 0.69 |
| KAl F₄ | 10.00 |
| | 100.00 |

The first three ingredients were mixed at room temperature until the 2-ethyl 4-methylimidazole is totally dissolved. Then the flux (potassium aluminum fluoride) is added. Aluminum panels were sprayed with this mix and the coating dried in an oven for 10′@80° C. The coatings produced were tough, stable and comparable to the solvent based systems.

What is claimed is:

1. Stabilizing normally solid polyalkylene carbonate resins against thermal and hydrolytic decomposition using the cyclic amines, imidazole or the substituted imidazole (2-ethyl 4-methylimidazole) at 5 to 35% on the solid polyalkylene carbonate resin.

2. Stabilizing normally solid polyalkylene carbonate resins against thermal and hydrolytic decomposition using a mixture of imidazole or the substituted imidazole (2-ethyl 4-methylimidazole) at 5 to 35% on the solid polyalkylene carbonate resin

3. Stabilizing polyalkylene carbonate resins according to claim one where the preferred addition of the imidazole or substituted imidazole (2-ethyl 4-methylimidazole) is from 10 to 30% on the solid polycarbonate resin.

4. Stabilizing polyalkylene carbonate resins according to claim one using any of the commercially available substituted imidazoles (e.g. “Curezol” and “Imcure”) alone or in combination with imidizole in the specified range.

5. Process for producing tough coatings with excellent adhesion to both ferrous and non ferrous metals using either of the cyclic amines of claim three in the specified range dissolved along with the polyalkylene carbonate resin in a suitable solvent (MEK, PMA) by mechanical mixing, coated onto a substrate, air dried and cured for at least 12 hours at ambient temperature to a maximum of 15 minutes at @150° C. The latter cure having the best adhesion and toughness.

6. A process according to claim five where powdered brazing flux (potassium aluminum fluoride) is dispersed into the dissolved polyalkylene carbonate resin/cyclic amine mix to produce a brazing coating for the aluminum brazing industry. The potassium aluminum fluoride should be in the range of 40 to 70 weight percent of the solid coating after the solvent is evaporated.

7. A process according to claim six where the flux is cesium aluminum fluoride in the same weight percent of 40 to 70 on the solid coating.

8. A process according to claim six where the powdered flux is a mixture of both potassium aluminum fluoride and cesium aluminum fluoride in any ratio in the same weight percent of 40 to 70 on the solid coating.
